(19) United States
(12) Patent Application Publication
(10) Pub. No.: US 2007/0174502 A1
(43) Pub. Date: Jul. 26, 2007

(54) METHOD AND APPARATUS OF IDENTIFYING TYPE OF NON-VOLATILE MEMORY

(76) Inventors: Cheng-Chieh Lin, Hsin-Chu City (TW); Jih-Liang Juang, I-Lan Hsien (TW); Ying-Chu Chen, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,072

(22) Filed: Jan. 23, 2006

(51) Int. Cl. G06F 3/00

(52) U.S. Cl. 710/16

(57) ABSTRACT

A method for detecting a type of a non-volatile memory. The method includes issuing one of a sequence of reading identification commands to detect the type of the non-volatile memory; obtaining a response data from the non-volatile memory; judging whether the response data matches any type of a plurality of types of non-volatile memory; utilizing another reading identification command of the sequence of reading identification commands to detect the type of the non-volatile memory when the response data does not match any type of the plurality of types of non-volatile memory; and determining the type of the non-volatile memory according to the response data when the response data match one type of the plurality of types of non-volatile memory.

### BACKGROUND

The present invention relates to device type identification, and more particularly, to a method and apparatus capable of identifying type of a non-volatile memory.

Flash memory has been widely used in computer systems and in many portable electrical devices. In the related art, parallel flash memories of different types support a fixed Read ID command set. That is, the type of implemented parallel flash memory can be easily identified using the Read ID command set. However, the serial flash memory is smaller than the parallel flash memory. Additionally, in the same storing density, the serial flash memory has a reduced pin count. As a result of its small size, low power consumption, and low cost of packaging, the serial flash memory can be utilized to accomplish higher-density storing mediums with lower cost so that the serial flash memory has become an ideal solution for users or designers to store data and program code in optical storing systems. As known to those skilled in this art, serial flash memories of different types have different Read ID command sets. Therefore, a Read ID command set suitable for a first serial flash memory differs from a Read ID command set suitable for a second serial flash memory. Assume that an optical disc drive adopts a serial flash memory to act as the ROM used to store the firmware. Identifying the type of the non-volatile memory becomes an important issue of updating the firmware.

### SUMMARY OF THE INVENTION

It is therefore one of the objectives of the claimed invention to provide a method and apparatus to distinguish a type of a non-volatile memory, to solve the above-mentioned problem.

According to an embodiment of the present invention, a method for detecting a type of a non-volatile memory is disclosed. The method includes issuing one of a sequence of reading identification commands to detect the type of the non-volatile memory; obtaining a response data from the non-volatile memory; judging whether the response data matches any type of a plurality of types of non-volatile memory; utilizing another reading identification command of the sequence of reading identification commands to detect the type of the non-volatile memory when the response data does not match any type of the plurality of types of non-volatile memory; and determining the type of the non-volatile memory according to the response data when the response data match one type of the plurality of types of non-volatile memory.

In addition, according to an embodiment of the present invention, a memory system is disclosed. The memory system includes a non-volatile memory; a machine readable medium, for storing a program; and a processing unit, coupled to the machine readable medium, for executing the program for: issuing one of a sequence of reading identification commands to detect the type of the non-volatile memory; obtaining a response data from the non-volatile memory; judging whether the response data matches any type of a plurality of types of non-volatile memory; utilizing another reading identification command of the sequence of reading identification commands to detect the type of the non-volatile memory when the response data does not match any type of the plurality of types of non-volatile memory; and determining the type of the non-volatile memory according to the response data when the response data match one type of the plurality of types of non-volatile memory.

The present invention makes use of auto detection to determine the type of a target non-volatile memory. In addition, if type of the target non-volatile memory is already known, the present invention provides a scheme to improve the type identification efficiency by writing a predetermined mark or a special pattern into a specific area of the non-volatile memory.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart illustrating auto detection of non-volatile memory type according to an embodiment of the present invention.

FIG. 2 is a flowchart illustrating type detection of utilizing a retrieved pattern to identify type of the non-volatile memory according to an embodiment of the present invention.

FIG. 3 is a block diagram of an optical disc drive according to an embodiment of the present invention.

### DETAILED DESCRIPTION

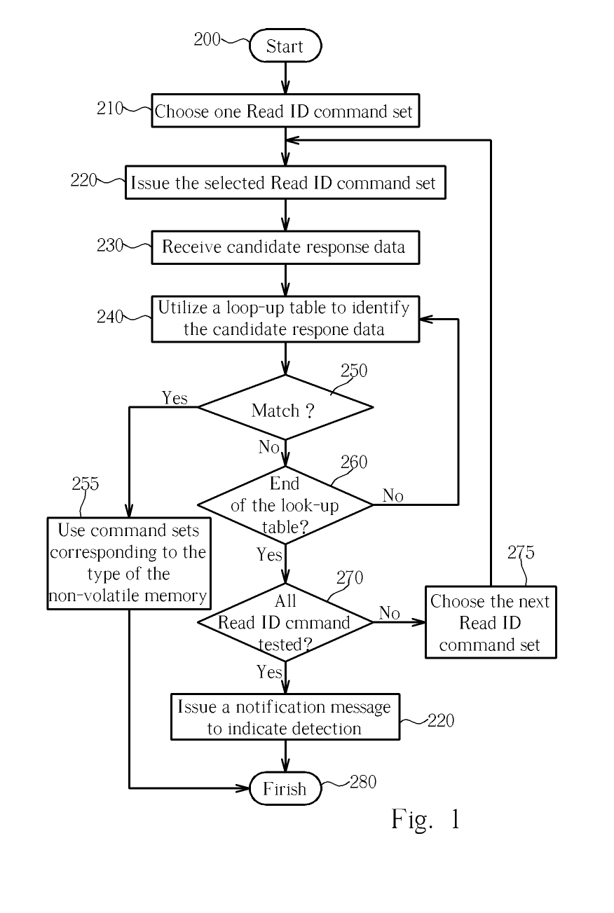

Please refer to FIG. 1. FIG. 1 is a flowchart illustrating auto detection of non-volatile memory type according to an embodiment of the present invention. The operation of detecting the type of the non-volatile memory is detailed as follows. When the type detection starts (step 200), one of the available Read ID command sets is chosen (step 210) and then this currently selected Read ID command set is issued to access the non-volatile memory (step 220). If the non-volatile memory under test supports the selected Read ID command set, it will output its type information in response to the selected Read ID command set. However, if the non-volatile memory under test does not support the selected Read ID command set, it will output undefined data or predetermined dummy data due to the unrecognizable Read ID command set. For clarity, the data in response to the selected Read ID command set is called candidate response data. After receiving the candidate response data (step 230) which might include wanted type information, undefined data or predetermined dummy data, the type detection process makes use of a look-up table to check if the received candidate response data is valid (steps 240-260).

The look-up table contains a plurality of predetermined response data mapped to a plurality of predetermined non-volatile memory types, respectively. In this embodiment, each predetermined response data includes a manufacturer ID and a device ID. Please note that the look-up table is not limited to containing predetermined response data having a manufacturer ID and a device ID. The look-up table is utilized for identifying the received candidate response data by comparing the received candidate response data with each of the stored predetermined response data. For example, the look-up table has ten predetermined response data D1-D10 mapped to ten predetermined non-volatile memory types T1-T10, respectively. The received candidate response data, corresponding to the currently selected Read ID command set, is firstly compared with the predetermined response data D1 (step 240). If the predetermined response data D1 and the received candidate response data do not match (step 250), it means that the tested non-volatile memory type is not the predetermined non-volatile memory type T1 associated with the predetermined response data D1. Because the look-up table still has predetermined response data D2-D10 to be checked (step 260), the type detection process proceeds to comparing the next predetermined response data D2 and the received candidate response data (step 240). In short, the predetermined response data D1-D10 are compared with the received candidate response data one by one. Suppose that the predetermined response data D5 matches the received candidate response data. Therefore, the tested non-volatile memory type is decided according to the predetermined non-volatile memory type T5 associated with the predetermined response data D5. Then, command sets complying with predetermined non-volatile memory type T5 are adopted for accessing the non-volatile memory, for example, updating the firmware stored in the non-volatile memory.

However, if each predetermined response data D1-D10 is not identical to the received candidate response data (step 270), it means that the currently selected Read ID command set is not applicable to the non-volatile memory under test. If there still exists an available Read ID command set to be tested (step 270), the next available Read ID command set is selected and issued to the non-volatile memory for obtaining a new candidate response data (steps 275, 220, 230). The above-mentioned operation is similarly performed to identify the candidate response data, and the related description is therefore not repeated for brevity. When all of the available Read ID command sets have been selected for type detection and no candidate response data matches the predetermined response data, the type detection issues a notification message to indicate the detection failure (step 275).

As mentioned above, the present invention identifies the type of non-volatile memory by utilizing a plurality of Read ID commands and then utilizing a plurality of candidate response data from the non-volatile memory to search a look-up table for a predetermined response data matching one of the candidate response data. This auto detection scheme is capable of distinguishing the type of non-volatile memory. In order to shorten detection time when the non-volatile memory type is required to be checked again in the future, the present invention further writes a specific mark for recording the type of the non-volatile memory. The specific mark maybe a special pattern recorded into a specific area of a non-volatile memory of the system, or maybe a specific hardware setting (such as a jumper setting) to represent the type of the non-volatile memory. The type of the non-volatile memory can be determined by the above-mentioned auto detection scheme or by other means or approaches. By the specific mark or means, no further Read ID commands is needed and the type of the non-volatile memory can be easily detected.

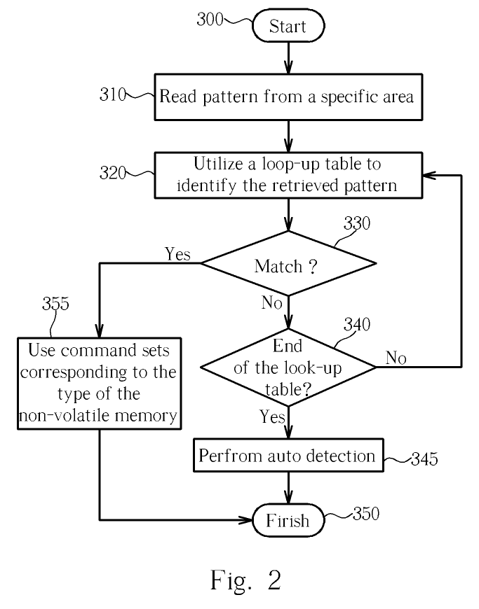

Please refer to FIG. 2. FIG. 2 is a flowchart illustrating type detection of utilizing a retrieved specific mark to identify type of the non-volatile memory according to an embodiment of the present invention. When the type detection process starts (step 300), it reads a specific mark from the specific area, which maybe record into the non-volatile memory or maybe a specific hardware setting (step 300). The retrieved specific mark might be the desired special pattern or undefined data. The type detection process makes use of a look-up table to check if the received ,mark is valid (steps 320-340). In this embodiment, the look-up table contains a plurality of predetermined marks mapped to a plurality of predetermined non-volatile memory types, respectively. Therefore, the look-up table is utilized to identify the retrieved mark by comparing the received specific mark with each of the stored predetermined patterns. Since the flow of checking the look-up table is identical to that described in the above auto detection scheme, further description is omitted for brevity.

Suppose that a predetermined mark matches the retrieved specific mark. Therefore, the type of tested non-volatile memory is decided according to a predetermined non-volatile memory type associated with the found predetermined pattern. Then, command sets complying with above predetermined non-volatile memory types are adopted for accessing the non-volatile memory, for example, updating the firmware stored in the non-volatile memory. However, if the retrieved specific mark cannot be identified using the look-up table, the type of non-volatile memory under test remains uncertain. In this embodiment, the above-mentioned auto detection scheme shown in FIG. 1 can be actuated to take over the type detection (step 345). Please note that, the specific mark can be programmed or changed by an application program, by a hardware circuit, or by the firmware that stored in the non-volatile memory. By the above different implementations, the specific mark could be implemented in different systems.

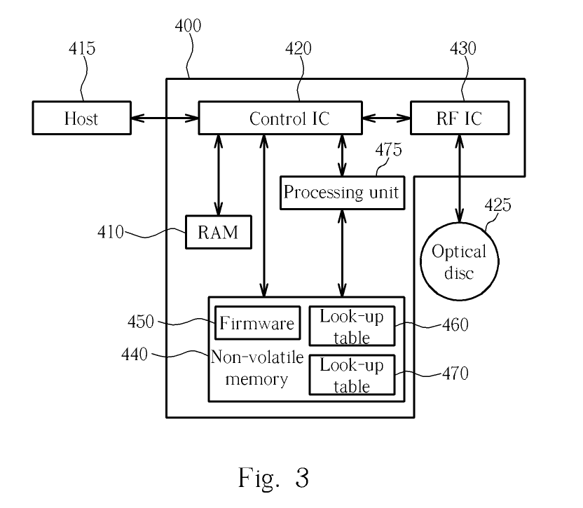

Please refer to FIG. 3. FIG. 3 is a block diagram of an optical disc drive 400 according to an embodiment of the present invention. The optical disc drive 400 is capable of accessing an optical disc 425 and communicating with the host 415. The optical disc drive 400 comprises a processing unit 475 (e.g. a microprocessor), a control IC 420, an RF IC 430, a non-volatile storage unit/non-volatile memory 440, and a volatile storage unit/RAM 410. All operations of the optical disc drive 400, including those of the control IC 420 used for controlling data processing in the optical disc drive 400 and the RF IC 430 used for processing RF signals read from the optical disc 425, are controlled by the processing unit 475. The processing unit 475 reads the firmware 450 from a non-volatile memory 440 and then executes it to control operations of the circuit components in the optical disc drive 400. As known to those skilled in this art, an update program is included in the firmware 450. Therefore, if the host 415 issues a firmware updating command to the control IC 420 for activating the firmware updating process, the update program of the firmware 450 is read from the non-volatile memory 440 and written into the RAM 410 for processing unit 475's execution. As shown in FIG. 3, two look-up tables 460, 470 are also stored in the non-volatile memory 440. The look-up table 460 contains a plurality of predetermined response data mapped to a plurality of predetermined non-volatile memory types, respectively. The other look-up table 470 contains a plurality of predetermined marks mapped to a plurality of predetermined non-volatile memory types, respectively. When the update program executed by the processing unit 475 runs the flows shown in FIG. 1 and FIG. 2, the look-up tables 460, 470 are referenced accordingly to determine the type of the non-volatile memory 440. For example, in the present invention, the update program includes a matching program, and the processing unit 475 executes the matching program to run the steps 240 and 250 for referencing the look-up table 460 to identify the response data.

Please note that the type detection method of the present invention can be applied to any electronic device (memory system) having a non-volatile memory. That is, the present invention is not limited to determining the type of non-volatile memory installed in an optical disc drive. Furthermore, although the look-up tables 460, 470 and the firmware 450, in this embodiment, are stored in the same non-volatile memory 440, the look-up tables 460, 470 in other embodiments can be stored in other non-volatile storage components in the optical disc drive 400. Please note that the method of utilizing Read ID command set is an embodiment of this invention. The above disclosure isn't limited by the Read ID command set. The Read ID command sets is part of the reading identification commands.

The present invention makes use of auto detection to determine the type of a target non-volatile memory. In addition, if type of the target non-volatile memory is already known, the present invention provides a scheme to improve the type identification efficiency by writing a predetermined mark or a special pattern into a specific area of the non-volatile memory.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for detecting a type of a non-volatile memory, the method comprising:
issuing one of a sequence of reading identification commands to detect the type of the non-volatile memory;
obtaining a response data from the non-volatile memory;
judging whether the response data matches any type of a plurality of types of non-volatile memory;
utilizing another reading identification command of the sequence of reading identification commands to detect the type of the non-volatile memory when the response data does not match any type of the plurality of types of non-volatile memory; and
determining the type of the non-volatile memory according to the response data when the response data match one type of the plurality of types of non-volatile memory.

2. The method of claim 1, wherein each of the response data comprises at least one identification information of the non-volatile memory.

3. The method of claim 2, wherein the step of judging the response data further comprises:
looking around a look up table having a plurality of identification information, each identification information corresponding to a type of non-volatile memory, to judge whether the response data matches any identification information in the look up table.

4. The method of claim 2, wherein the step of judging the response data further comprises:
utilizing a matching program to compare the response data to a plurality of identification information, each identification information corresponding to a type of non-volatile memory, to judge whether the response data matches any type of non-volatile memory.

5. A method for determining a type of a non-volatile memory that has been programmed, the method comprising:
reading a specific area for a specific mark;
identifying the predetermined mark; and
determining the type of the non-volatile memory according to the specific mark.

6. The method of claim 5, wherein the step of reading the mark to determine the type of the non-volatile memory further comprises:
comparing the specific mark with a plurality of predetermined marks, each mark corresponding to a type of non-volatile memory; and
if the specific mark is identical to a predetermined mark, determining the type of the non-volatile memory according to the predetermined mark.

7. The method of claim 6, wherein the step of comparing the mark with the predetermined marks comprises:
providing a look-up table having the predetermined marks corresponding to the predetermined non-volatile memory types, respectively; and searching the look-up table for a predetermined mark identical to the specific mark read from the non-volatile memory.

8. The method of claim 5, wherein the specific area is in the non-volatile memory.

9. The method of claim 5, wherein the specific area is a specific hardware setting.

10. A memory system, comprising:
a non-volatile memory;
a machine readable medium, for storing a program; and
a processing unit, coupled to the machine readable medium, for executing the program for:
issuing one of a sequence of reading identification commands to detect the type of the non-volatile memory;
obtaining a response data from the non-volatile memory;
judging whether the response data matches any type of a plurality of types of non-volatile memory;
utilizing another reading identification command of the sequence of reading identification commands to detect the type of the non-volatile memory when the response data does not match any type of the plurality of types of non-volatile memory; and
determining the type of the non-volatile memory according to the response data when the response data match one type of the plurality of types of non-volatile memory.

11. The memory system of claim 10, wherein the machine readable medium is part of the non-volatile memory.

12. The memory system of claim 10, wherein each of the plurality of predetermined response data comprises at least one identification information of the non-volatile memory.

13. The memory system of claim 12, further comprising:
a look up table having a plurality of identification information, each identification information corresponding to a type of non-volatile memory; and
wherein the processing unit looks around the look up table to judge whether the response data matches any identification information in the look up table.

14. The memory system of claim 10, wherein after the type of the non-volatile memory is determined, the processing unit further executes the program for writing a specific mark indicating the type of the non-volatile memory into a specific area; and
if the type of the non-volatile memory is to be detected again, the processing unit further executes the program for reading the specific mark stored in the specific area to determine the type of the non-volatile memory.

15. The memory system of claim 10, wherein the non-volatile memory is a serial flash memory.

16. A memory system for determining a type of a non-volatile memory, comprising:
a non-volatile memory;
a specific mark stored in a specific area, said the specific mark identifying the type of the non-volatile memory;
a machine readable medium, for storing a program; and
a processing unit, coupled to the machine readable medium, for executing the program for:
reading the specific area for the specific mark;
identifying the specific mark; and
determining the type of the non-volatile memory according to the specific mark.

17. The memory system of claim 16, wherein the processing unit executes the program to identify the specific by:
comparing the specific mark with a plurality of predetermined marks, each predetermined mark corresponding to a type of non-volatile memory; and
if the mark is identical to a predetermined mark, determining the type of the non-volatile memory according to the predetermined mark.

18. The memory system of claim 17, wherein the machine readable medium further stores a look-up table having the predetermined marks, and the processing unit executes the program to compare the mark with the predetermined marks by:
searching the look-up table for a predetermined mark identical to the mark read from the non-volatile memory.

19. The memory system of claim 16, wherein the specific area is in the non-volatile memory.

20. The memory system of claim 16, wherein the specific area is a specific hardware setting.

21. The memory system of claim 16, wherein the non-volatile memory is a serial flash memory.
